(19) United States
(12) Patent Application Publication
(10) Pub. No.: US 2004/0156270 A1
(43) Pub. Date: Aug. 12, 2004

(54) Wrist-type watch having a flexible electro-luminance(EL) film display

(76) Inventor: Yuan Sung Weng, Taipei (TW)

Correspondence Address: BUCKNAM AND ARCHER, 1077 Northern Blvd., Roslyn, NY, 11576, US

(21) Appl. No.: 10/639,805

(22) Filed: Aug. 12, 2003

(30) Foreign Application Priority Data
Oct. 24, 2002 (TW) 091216979

(51) Int. Cl. G04C 19/00

(52) U.S. Cl. 368/82

(57) ABSTRACT

The present invention relates to a wrist-type watch having a flexible electro-luminance(EL) film display, which includes a housing for defining an accommodation space, the accommodation space comprising a power supply unit for supplying a working voltage, a timer unit for providing a time, a memory unit for storing an image data, an EL film display unit for displaying the time and the image data, a display control unit for controlling display of the organic El film display unit, an input unit for inputting the data, and a control circuit unit for controlling action of each of above components, in which the organic EL film display unit has two flat electrodes, between both of which, there are an EL material and a resin substrate, thereby the wrist-type watch has a design of flexible and larger sized display panel.

### BACKGROUND

1. Field of the Invention

The present invention relates to a wrist-type watch having a flexible electro-luminance(EL) film display, and more particular to a wrist-type watch which utilizes flexibility of the flexible electro-luminance(EL) film, self-emitting light, and characteristic of not needing a back light, so as to increase variation of watch appearance, to increase a display area, as well as to reduce a power-consumption.

2. Description of the Prior Art

Recently, as technical development of miniature of wrist-type computers and increasing demand of acquiring images and information, wrist-type watches are used, and computers and various applications of wrist-type computers are innovative products needed by human being. There is no doubt that it is very convenient for people to wear the wrist-type watches as they desire, so the wrist-type watches must be very compact and power-saving.

Nowadays, displays, such as STN, TFT etc. on the market are high power-consumption, thick and huge in volume on the market, and use glasses as substrates. However, the wrist-type computers require light in weight and compact in volume. Because areas of the displays are too small, it is not very easy for users to watch the displays clearly, and the information that is shown by such small displays is limited.

Therefore, in order to solve the above problems, there is necessary to develop a wrist-type watch which has a flexible display and matches with a curvature of the wrist of human being, so as to increase size of display panel to allow more information to be displayed, and which is also ergonomic to make a user more comfortable.

### SUMMARY OF THE INVENTION

Therefore, an object of the present invention is to provide a wrist-type watch having a flexible electro-luminance(EL) film display, which utilizes a flexibility of an organic EL film and uses a soft resin as a substrate instead of hard glass substrate, as well as utilizes the organic EL display that is self-emitting light and does not need a back light, such that even in a dark environment, a user can clearly observe the display which reduces the thickness and weight and which can be an curved shape due to its flexibility, so as to increase size of display panel such that more information can be displayed to facilitate the user to watch. Moreover, variation of designed shapes of watch can be increased, fashion property of the watch can be increased, as well as the watch can match with a curvature of a human being wrist, so as to achieve a wrist-type computer which is curve-shaped, and which is ergonomic, so that functions of the watch can be promoted.

In order to achieve the above object, according to an aspect of the present invention, a wrist-type watch having a flexible electro-luminance(EL) film display is provided, which includes a housing for defining an accommodation space, the accommodation space comprising a power supply unit for supplying a working voltage, a timer unit for providing a time, a memory unit for storing an image data, an EL film display unit for displaying the time and the image data, a display control unit for controlling display of the organic El film display unit, an input unit for inputting the data, and a control circuit unit for controlling action of each of above components, in which the organic EL film display unit has two flat electrodes, between both of which, there are an EL material and a resin substrate, thereby the wrist-type watch has a design of flexible and larger sized display panel.

Moreover, according to above aspect of the present invention, the wrist-type watch further comprises a transmitting interface unit connected to the input unit and used to link with other devices for transmitting the image data, in which the other devices comprise personal computers, personal digital assistants, digital cameras and so on.

Furthermore, according to the aspect of the present invention, the transmitting interface unit is a bi-directional data transmitting infrared transceiver.

In addition, according to above aspect of the present invention, the thin film-type display panel of the EL film display unit can be a monochromatic-type or multi color-type design in color, and can be an AC (alternate current)-type or DC (direct current)-type design in drive, and can be an active matrix-type or passive matrix-type in selection of address.

### BRIEF DESCRIPTION OF DRAWINGS

The above objects, features and advantages of the present invention will become more clear with reference to the following drawings, in which like elements are represented by like reference numerals.

FIG. 1 is a block diagram showing a construction of a preferred embodiment of the present invention;

FIG. 2 is a schematic view showing a construction of a display panel of a flexible organic EL display; and

FIG. 3 is a schematic view showing a product of the preferred embodiment of the present invention.

### DETAILED DESCRIPTION OF THE INVENTION

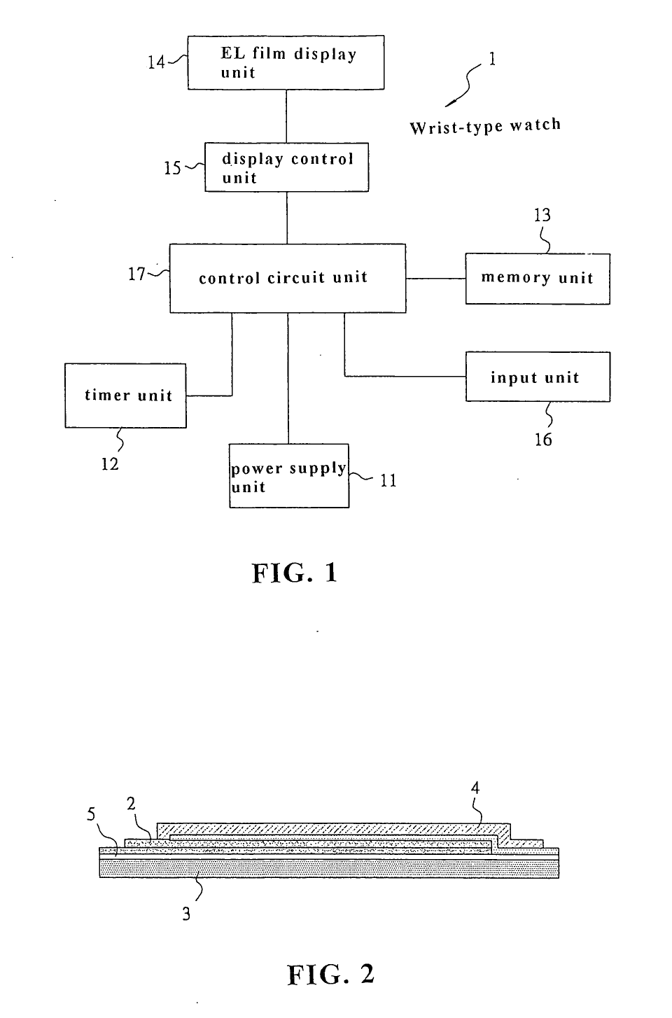

Referring to FIG. 1, FIG. 1 shows a construction block diagram of a preferred embodiment of a wrist-type watch with a flexible organic EL film display. As shown in the Figure, the wrist-type watch 1 comprises a power supply unit 11, a timer unit 12, a memory unit 13, a organic EL film display 14, a display control unit 15, an input unit 16, and a control circuit unit 17.

The power supply unit 11 is a DC voltage source, like a battery cell, which outputs a working voltage. The timer unit 15 receives the working voltage supplied by the power supply unit 11 for providing a time. The memory unit 13 is used to store data that contain images.

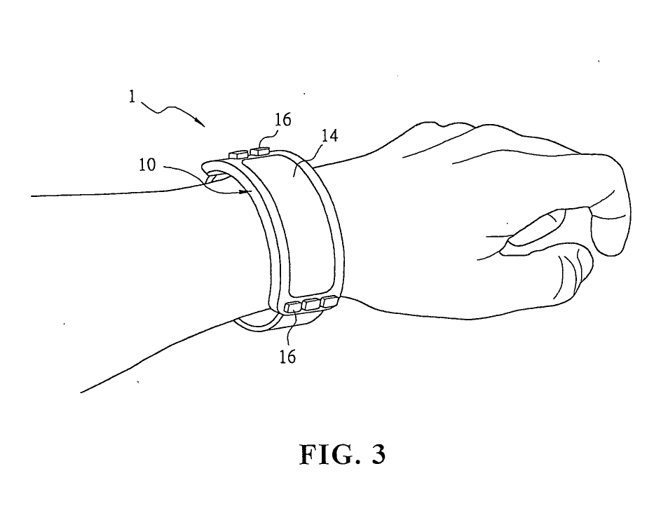

The organic EL film display unit 14 is a flexible organic EL film display which is used to display time and image data, and which has a flexible flat display panel, rectangular-shaped and made of EL material, in which the EL material is arranged between two electrodes, and emits light in an electric field between the two electrodes, in which one of the two electrodes is a transparent electrode. The EL material, for example, can be selected from ZnS, GdS, ZnSe, GdSe, and the like, and can be made to several micrometers thick of a thin layer through vaporization. When the EL material is provided with the electric field, then it emits light. The display of the EL film display unit 14 can be a monochromatic-type or multi color-type design in color, and can be an AC (alternate current)-type or DC (direct current)-type design in drive, and can be an active matrix-type or passive matrix-type in selection of address. However the present invention is not limited to the above type of EL film display unit 14. As long as they have compact, light, and flexible characteristics, they can be employed. FIG. 2 shows a construction of display panel of flexible organic EL film display, in which a soft, organic EL film 2 and a water-proof isolation film 5 are arranged on a resin substrate 3, and then the display panel of flexible organic EL film display is covered with a sealing protecting film 4. For the purpose of simplification, descriptions of the upper electrode and lower electrode are omitted here.

Returned to FIG. 1, the display control unit 15 is used to control the EL film display unit 14, and can supply a display control voltage of each pixel in the display panel and picture repeating rate, in which the control voltage is also called modulation voltage or threshold voltage, and can independently control the addressed pixels and make them emit monochromatic light. An input unit 16 is used to input data, in which the input unit 16 can directly input desired data through a control button and selection button (not shown), or is connected to other device, such as a personal computer (PC), personal digital assistant (PDA), digital camera, through a transmitting interface unit of an infrared transceiver, in order to transmit and receive image data in bi-directional manner.

A control circuit unit 17 is used for processing the time and data, and controlling action of each component. For example, the control circuit unit 17 may handle the time, data, image, and action of each component, based on a selection mode determined by a selection button of the input unit 16.

FIG. 3 shows the wrist-type watch 1 of FIG. 1. Because this product has the flexible organic EL film display 14, thus the advantages of light-weighted, compact, and large sized display panel can be achieved. Also, both of the display unit 14 and the housing can be designed as a curved shape, thereby it can closely abut against a wrist of human being. In addition, the input unit 16 located above and beneath the wrist-type watch is designed to meet the ergonomics. The pushbottons, such as a control button and a selection button are arranged on the input unit 16.

While this invention has been described in conjunction with the preferred embodiment described above, it will now be possible for a person who is skillful in that art to change and modify this in various other manners without departing from the scope and spirit of the invention. However, these changes and modifications should be considered as falling within the appended claims of the present invention.

List of of Reference Numerals

1 wrist-type watch

2 organic EL element

3 resin substrate

4 sealing protecting film

5 water-proof isolation film

10 housing

11 power supply unit

12 timer unit

13 memory unit

14 EL film display unit

15 display control unit

16 input unit

17 control circuit unit

What is claimed is

1. A wrist-type watch having a flexible organic EL film display, including a housing which defines an accommodation space, said accommodation space comprising:
a power supply unit for supplying a working voltage;
a timer unit for providing a time;
a memory unit for storing an image data;
an organic EL film display for displaying said time and image data;
a display control unit for controlling display of said EL film display unit;
an input unit for inputting said data; and
a control circuit unit for controlling action of each of above components, in which said organic EL film display unit has two flat electrodes, between both of which, there are an EL material and resin substrate, thereby said wrist-type watch has a flexible and larger sized display panel.

2. The wrist-type watch having a flexible organic EL film display according to claim 1, further comprising:
a transmitting interface unit connected to said input unit, and used to link with other devices including a personal computer (PC), personal digital assistant (PDA), digital camera or the like, for transmitting the image data.

3. The wrist-type watch having a flexible organic EL film display according to claim 1 or 2, wherein said transmitting interface unit is a bi-directional infrared transceiver or other transmitting transceiver.

4. The wrist-type watch with a flexible organic EL film display according to claim 1, wherein said thin film-type display of said organic EL film display unit can be a monochromatic-type or multi color-type design in color, and can be an AC (alternate current)-type or DC (direct current)-type design in drive, and can be an active matrix-type or passive matrix-type in selection of address.
